(19) United States
(12) Patent Application Publication
(10) Pub. No.: US 2015/0300088 A1
(43) Pub. Date: Oct. 22, 2015

(54) MOTORIZED MANOEUVRING DEVICE INTENDED TO MANOEUVRE A MOVING WINDABLE FABRIC SCREEN OF A WINDOW OR PROJECTION SCREEN COVER DEVICE

(71) Applicant: SOMFY SAS, Cluses (FR)

(72) Inventors: Sébastien Lemaitre, Cluses (FR); Julien Peillex, Cluses (FR); Ronan Georgeault, Cluses (FR)

(73) Assignee: SOMFY SAS, Cluses (FR)

(21) Appl. No.: 14/755,688

(22) Filed: Jun. 30, 2015

Related U.S. Application Data
(63) Continuation-in-part of application No. 14/408,040, filed on Dec. 15, 2014.

(30) Foreign Application Priority Data
Jun. 13, 2012 (FR) 1255524

(51) Int. Cl. E06B 9/72

(52) U.S. Cl. CPC E06B 9/72

(57) ABSTRACT

A motorized maneuvering device (1) intended to manoeuvre a moving windable fabric screen (3), the motorized maneuvering device:
includes an actuator (4), comprising a hollow housing (41) containing a gear
motor and a mounting end-plate
(7a) which has a first support (11) extending from the end-plate along a first longitudinal axis (X-X′) and cooperating with the housing (41) of the actuator (4) and a second support (12) extending from the end-plate along a second axis distinct from the first axis (Ya-Ya′, Z-Z′). The hollow housing, notably the tubular hollow housing, of the actuator, is closed by the first end-plate support.

The invention relates to a moving windable fabric screen installation, of the window or projection screen cover type, provided with a motorized winding element. The invention relates more specifically to a motorized maneuvering device intended to manoeuvre a movable windable fabric screen of a window or projection screen cover device and to a window or projection screen cover device comprising such a maneuvering device. The invention notably relates to a motorized home automation system for maneuvering a moving screen in a conventional mounting configuration for which the winding shaft has to be kept in a fixed position relative to a frame and to a motorized maneuvering home automation system for an inverse-mounted screen, in which the winding shaft is suspended on the fabric and therefore can be moved relative to its bearing structure (building or moving structure such as a load bar or an arm of an awning).

Such a screen is described in the unpublished patent application PCT/EP11073888. In this application, the motorized maneuvering device is intended to be suspended by the fabric and comprises:
a winding tube that moves about a first axis and on which the fabric is intended to be wound,
an actuator arranged at least partially in the tube,
a first means for fixing a first end of the fabric to the winding tube.

The weight of the maneuvering device creates a fabric unwinding torque. The device comprises an unwinding torque neutralizing means that acts exclusively by interaction with gravity and/or with the fabric. This neutralizing means notably comprises a torque recovery bar mounted between two lateral end-plates.

In the different types of screens, the actuator is mounted inside the winding tube. The output shaft of the actuator drives the winding tube in rotation when the motor of the actuator is powered.

The actuator comprises a hollow tubular housing, closed by a part called head of the actuator. The latter is conventionally fixed onto an accessory that is itself added onto a frame, an end-plate or on a side of a casing. The winding shaft is kept free to rotate on the actuator, notably on a portion of tubular housing of the actuator.

The aim of the invention is to provide a moving screen maneuvering device that improves the maneuvering devices known from the prior art. In particular, the invention proposes a maneuvering device of simple and compact architecture, involving a support element that is simple, reliable and versatile. The aim of the invention is also to provide a moving screen maneuvering device in which the actuator is incorporated without accessories, the device itself acting as actuator head. Moreover, another aim of the invention is to provide a support element that can suit different tube-based or winding shaft-based home automation system architectures.

According to an aspect of the invention, a motorized maneuvering device is intended to manoeuvre a moving windable fabric screen. The motorized maneuvering device comprises:
an actuator, comprising a hollow housing containing a gear motor,
an end-plate.

The end-plate comprises a first support extending from the end-plate along a first longitudinal axis and cooperating with the housing of the actuator.

The end-plate comprises a second support extending from the end-plate along a second axis distinct from the first.

The first support can comprise at least one first rotation stopping element, notably at least one groove, respectively at least one rib, in particular at least one first rotation stopping element formed on a shafted part of the first support. The housing can comprise at least one second rotation stopping element, notably at least one rib, respectively at least one groove, in particular at least one second rotation stopping element formed on inner walls of the housing. The first and second rotation stopping elements cooperate to link in rotation, notably to link in rotation about the first longitudinal axis, the first support and the housing.

The end-plate and its first and second supports can be produced as a single piece.

The first support can be at least partially inserted into the hollow housing of the actuator.

The hollow housing, notably the tubular hollow housing, of the actuator can be closed by the first end-plate support.

The second support can be intended to cooperate with a torque neutralizing element acting by interaction with the fabric.

The second support can be intended to cooperate with a frame on an axis substantially at right angles to the longitudinal axis of the first support.

The end-plate can comprise a first bore intended to receive a connection and/or electronic part of the actuator, the first bore being produced inside the first support.

The end-plate can comprise a second bore on its outer lateral face and a cover intended to close this bore.

The first and the second bores of the end-plate can be connected to one another.

The end-plate can comprise a through hole between the second bore and its inner lateral face, the hole emerging outside the diameter of the hollow housing of the actuator for the entry of a cable.

A first guiding path for an electrical wire can be positioned in the second bore.

The inner lateral face of the end-plate can comprise a second guiding path for an electrical wire.

The two supports can extend from the inner lateral face of the end-plate.

The motorized device can comprise an annular surface on the inner lateral face of the end-plate against which a bearing ring mounted free to rotate about the housing of the actuator can bear.

According to an aspect of the invention, a motorized home automation system comprises a motorized device as defined previously, a bearing ring rotating freely on the housing of the actuator, a winding tube, mounted to slide on the bearing ring, the bearing ring bearing on the inner face of the end-plate and a second end-plate comprising a winding tube support element.

According to another aspect of the invention, an end-plate for a radio controlled motorized maneuvering device comprises:
a first guiding path formed by a groove in the end-plate,
the first guiding path being shaped for receiving and holding a radio antenna.

In other embodiments:
the end-plate comprises a second guiding path formed by a groove in the end-plate, the second guiding paths being shaped for receiving and holding part of a radio antenna;
the first and second guiding paths have a first common end and second ends;
the first guiding path comprises a part which extends in whole or in part along a perimeter of the outer face.

According to another aspect of the invention, a motorized maneuvering device for maneuvering a moving element comprises such an end-plate and a radio antenna.

According to another aspect of the invention, a method of configuring a motorized maneuvering device comprises the following steps:
providing a motorized maneuvering device for maneuvering a moving element, the motorized maneuvering device comprising an such end-plate and a radio antenna;
removing the radio antenna from the first guiding path and shaping and setting the radio antenna in a different configuration.

According to another aspect of the invention, a method of configuring a motorized maneuvering device comprises the following steps:
providing a motorized maneuvering device for maneuvering a moving element, the motorized maneuvering device comprising an such end-plate and a radio antenna;
removing the radio antenna from the first guiding path and shaping and setting the radio antenna in the second guiding path.

According to another aspect of the invention, a motorized maneuvering device for maneuvering a moving windable fabric screen comprises:
an actuator, comprising a hollow housing containing a motor and a gear;
a mounting end-plate, the end-plate comprises a first support extending from the inner lateral face of the end-plate along a first longitudinal axis, the hollow housing, notably the tubular hollow housing, of the actuator being closed by the first end-plate support,

wherein the end-plate comprises a first guiding path for an electrical wire in a bore on a outer lateral face of the end-plate.

In other embodiments:
the first support comprises at least one first rotation stopping element, notably at least one groove, respectively at least one rib, in particular at least one first rotation stopping element formed on a shafted part of the first support and in that the housing comprises at least one second rotation stopping element, notably at least one rib, respectively at least one groove, in particular at least one second rotation stopping element formed on inner walls of the housing, the first and second rotation stopping elements cooperating to link in rotation, notably to link in rotation about the first longitudinal axis, the first support and the housing;
the actuator comprises a radio receiver and in that the guiding path permits to store therein an antenna wire;
the guiding path takes the form of pins arranged facing one another and between which a part of the antenna wire can be wedged;
the end-plate comprises a cover intended to close the bore on the outer lateral face;
the actuator comprises inside the hollow housing electromechanical components such as the motor, the gear, a control electronic;
the end-plate comprises a bore intended to receive a connection and/or electronic part of the actuator, said bore being produced inside the first support;
the bore on the outer face of the end-plate and the bore produced inside the first support are connected to one another;
the end-plate comprises a through hole between the bore produced inside the first support and its inner lateral face for the entry of a cable, notably for the entry of a power supply cable;
the motorized device comprises an annular surface on the inner lateral face of the end-plate against which a bearing ring mounted free to rotate about the housing of the actuator can bear, and
the first support cooperates with the housing of the actuator and in that it comprises a second support extending from the end-plate along a second axis distinct from the first.

According to another aspect of the invention, a motorized home automation system comprises such a motorized device, a bearing ring rotating freely on the housing of the actuator, a winding tube, mounted to slide on the bearing ring, the bearing ring bearing on the inner face of the end-plate and a second end-plate comprising a winding tube support element; the system comprising a radio-receiver and a power supply device of the actuator comprising an electrical energy storage element.

In particular, the maneuvering actuator is inserted into the winding tube, at one of its ends, whereas the power supply device is inserted into the winding tube, at its other end.

Advantageously, the end-plate is fixed onto an accessory that is itself added onto a frame or on a side of a casing.

The invention will be better understood on reading the following description, given purely as an example and with reference to the attached drawings in which:

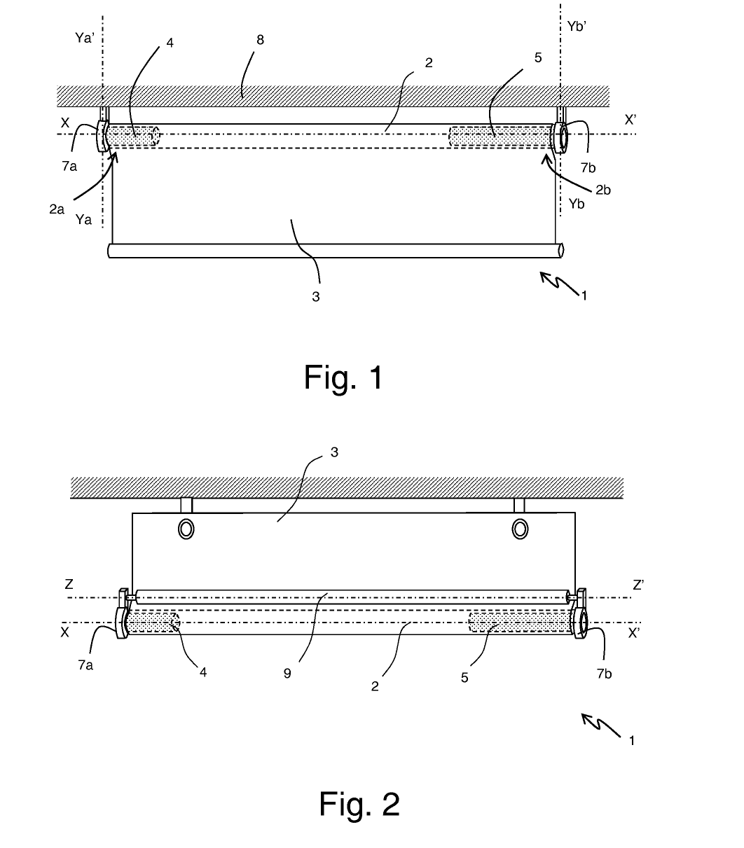

FIG. 1 is a representation of a first embodiment of a motorized home automation system for maneuvering a moving screen in a conventional mounting configuration.

FIG. 2 is a representation of a second embodiment of a motorized home automation system for maneuvering a moving screen in an inverse-mounted configuration.

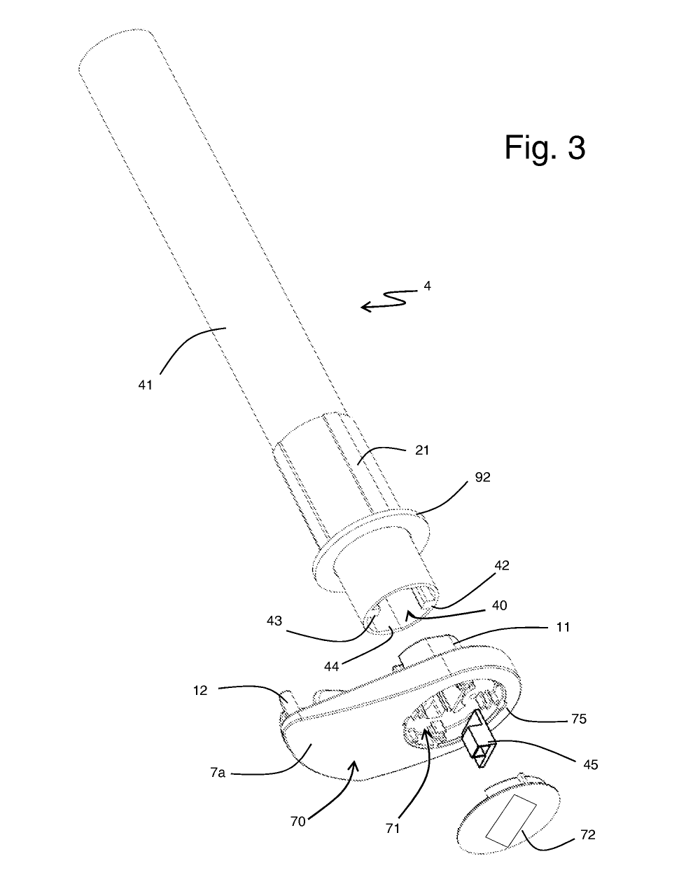

FIG. 3 represents, in an exploded view, a part of a motorized device for maneuvering a moving screen.

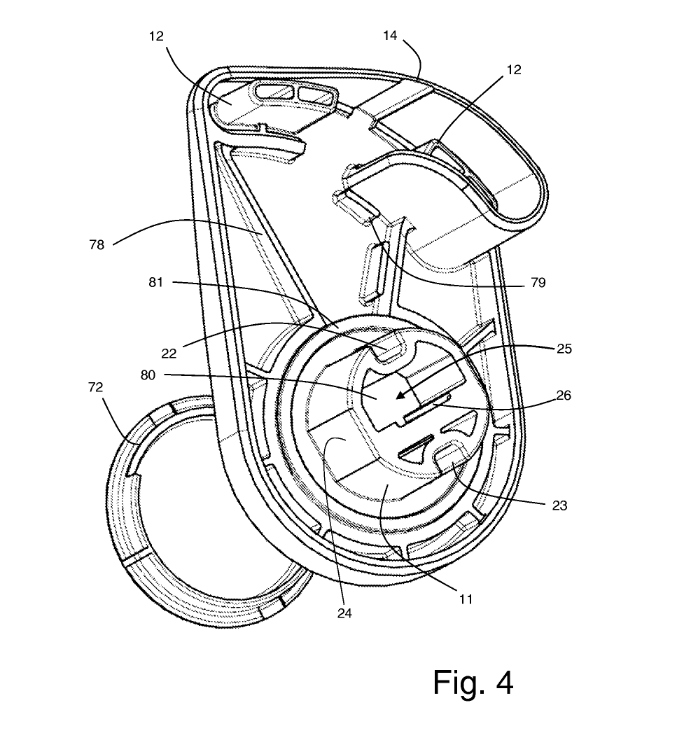

FIG. 4 represents, in perspective, a view of the outer face of an end-plate.

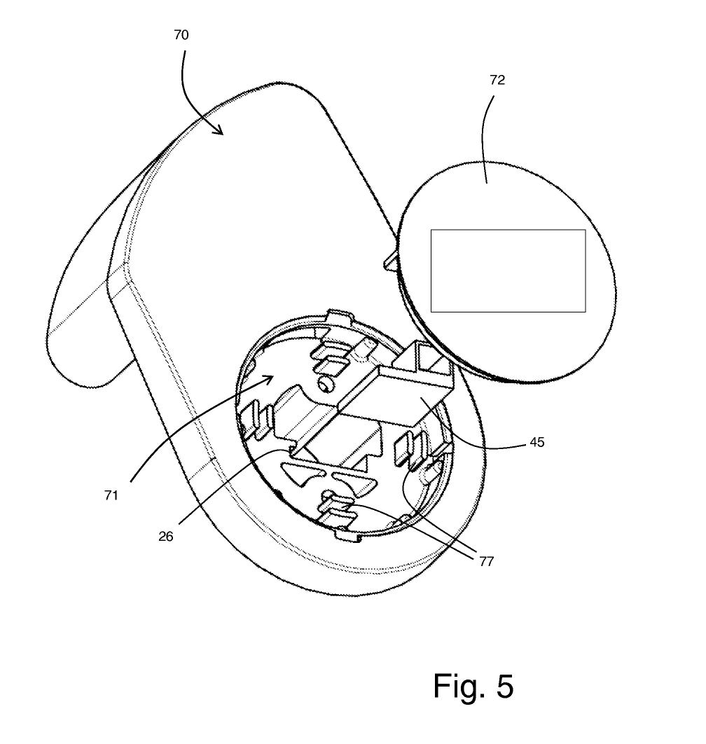

FIG. 5 represents, in perspective, a view of the inner face of the end-plate.

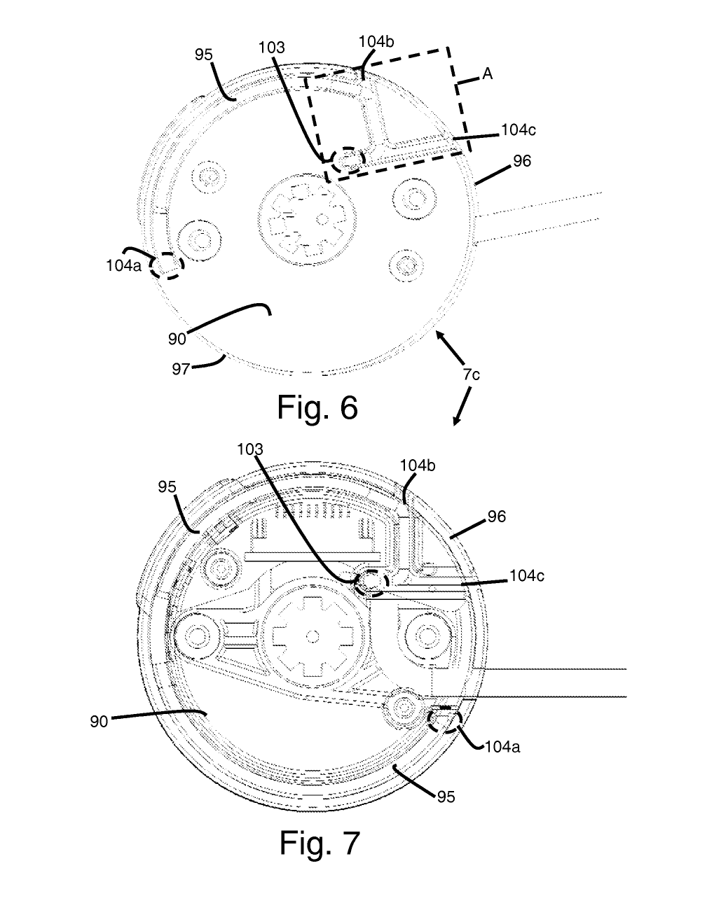

FIGS. 6, 7 and 10 represent views of the outer face of a variant embodiment of the end-plate, an antenna being set in a first path.

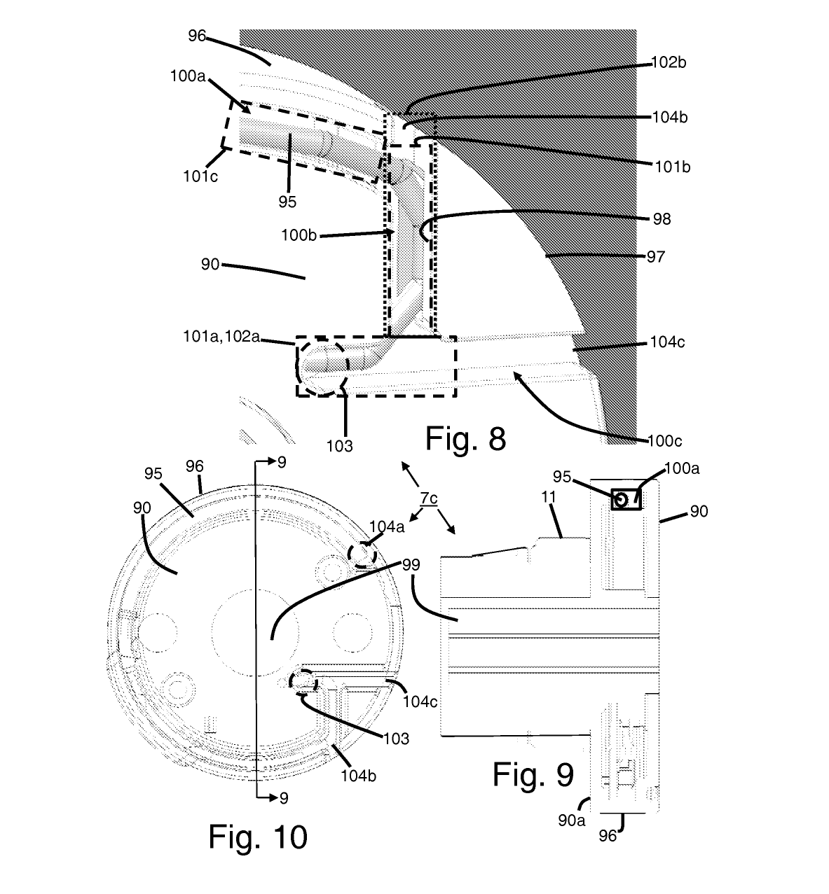

FIG. 8 represents a part A of FIG. 6.

FIG. 9 represents a sectional view thereof taken on line 9-9 of FIG. 10.

An embodiment of a motorized maneuvering home automation system, represented in FIG. 1, allows for the motorized maneuvering of a moving screen 3, notably a screen that can be wound about a winding tube 2, such as a blind. It is notably designed to be used to block or restrict the penetration of sunlight through an opening of a building.

The home automation system or motorized screen system comprises a winding tube maneuvering actuator 4. This actuator is preferably arranged partially or totally in the winding tube. The maneuvering actuator is said to be standalone, that is to say that it is powered by its own power supply device 5 comprising an electrical energy storage element 6. The maneuvering actuator is inserted into the winding tube, at one of its ends, whereas the power supply device is inserted into the winding tube, at its other end.

The actuator sets the winding tube in motion in a known manner. The moving screen is attached by one of its ends to the tube. Thus, the rotation of the winding tube causes, depending on its direction, the screen to be wound onto or unwound from the tube. The actuator and the winding tube extend along a first axis X-X′.

The system 1 comprises two end-plates 7a, 7b on either side of the winding tube. These end-plates are used to hold the motorized screen system on a fixed structure or frame 8, for example a ceiling or a wall. In particular, the end-plates 7a and 7b support the winding tube on two axes Ya-Ya′ and Yb-Yb′, parallel to one another and at right angles to the first axis X-X′. Other configurations are also possible. In this first embodiment, the winding tube remains fixed (excluding its rotation about its axis X-X′) relative to the structure of the building and the fabric is wound around this winding tube. The end-plate 7a close to the actuator is called first end-plate or motor end-plate, and the end-plate 7b at the opposite end of the tube is called second end-plate.

In a second embodiment represented in FIG. 2, the motorized screen system is intended to be linked to the structure of the building exclusively by the screen, that is to say that the motorized screen system is a system suspended by the screen and in which the winding tube is translated, notably is translated vertically, as the screen is wound or unwound. Thus, all the forces exerted on the system are taken up by the screen. Preferably, there is no other contact or link between the system and the building. The end-plates 7a and 7b are then used to hold the winding tube relative to the screen, notably by virtue of a rotation torque recovery bar 9 in contact with the screen and held between the end-plates in a direction Z-Z′, parallel to the axis X-X′. The other references remain unchanged.

As represented in FIGS. 3 and 4, the actuator comprises a hollow housing 41, inside which are housed the electromechanical components (not represented) such as the motor, the gear, the radio receiver, the control electronics, etc.

The inner wall of the housing 40 has one or more ribs 42, 43, and planar areas 44. The planar areas can include a groove (not represented), allowing for the translational guidance of at least some of the electromechanical components, for example a printed circuit supporting the control electronics.

It should be noted that the tubular housing can comprise a closing cover (not represented), inserted into the housing to protect the electromechanical components of the actuator, and through which power supply wires enter. However, even in this case, the end of the housing is hollow.

A crown ring 21 with collar 92 is mounted to rotate freely on the housing. It serves as a bearing for the winding tube when the actuator is inserted into the tube.

The housing of the actuator is closed by the first end-plate 7a, a first support 11 of which cooperates with the hollow end of the housing of the actuator. In particular, the first support of the motor end-plate takes the form of a support shaft extending substantially at right angles to the end-plate on an inner face 71. The support shaft is provided with at least one longitudinal channel or groove 22, 23. The channels cooperate with the ribs 42, 43 formed on the inner walls of the housing of the actuator. The grooves-ribs assembly makes it possible both to guide the assembly of the housing on the support shaft and also to ensure the recovery of the rotational forces linked to the motor (torque recovery). The support shaft also comprises one or more flats 24, corresponding to the planar areas on the inner surface of the hollow housing, for this same purpose. The actuator is then slidingly mounted on the support shaft, before being translationally immobilized, if necessary, on the shaft or on the motor end-plate. Thus, the first support can comprise at least one first rotation stopping element, notably at least one groove 22, 23, respectively at least one rib, in particular at least one first rotation stopping element formed on a shafted part of the first support 11. Moreover, the housing 41 can comprise at least one second rotation stopping element 42, 43, notably at least one rib 42, 43, respectively at least one groove, in particular at least one second rotation stopping element formed on inner walls of the housing. The first and second rotation stopping elements advantageously cooperate to link in rotation, notably to link in rotation about the first longitudinal axis XX′, the first support and the housing.

The motor end-plate and the tubular housing of the actuator are therefore directly linked, with no other intermediary. In particular, the actuator does not comprise any head, blocking the housing and serving as holding point. In other words, the head of the actuator is formed by the end-plate which also has a second support function, notably a support function for a torque neutralizing element or a support function for the home automation system.

The mounting thus saves in thickness: the motor end-plate itself takes up the rotational torque imparted by the actuator, by being directly connected to the hollow housing 41 or hollow body of the actuator. Thus, the winding tube and consequently the border of the fabric can be as close as possible to the inner face of the end-plate.

The support shaft is provided with a first bore 25 comprising, on its inner walls, at least one rail 26 forming a support and guiding element for an electronic control card 45 for the actuator. The latter is thus at least partially located inside the housing of the actuator when the latter is assembled on the support shaft and when the electronic card is slid along the rails inside the bore of the support shaft.

Advantageously, the bore in the support shaft is a through bore and the motor end-plate 7a also includes a through bore 71, forming an opening on the outer part 70 of the end-plate, that can be closed by a cover 72. This opening makes it possible to access in particular the electronic card without dismantling the rest of the system. In particular, the end-plate comprises notches 75, notably allowing for the passage of a tool, such as a flat screwdriver, to act, notably by a lever action, to raise the cover and access the electronic card.

The electronic card can also be provided with interface elements, for example a programming button, which can thus be accessed when the cover of the end-plate is removed, without dismantling the rest of the system. In maintenance situations, it is very simple to dismantle the system and disassemble the different parts.

The end-plate also comprises a second support element 12. The latter allows it to be fixed to a wall or a ceiling, in the first embodiment, or to the rotation torque recovery bar 9, in the second embodiment. In both embodiments, the second support element is distinct from the first support element and acts on a distinct axis.

In the first embodiment, the second support element comprises a foot which can be mounted on a wall or on a ceiling, by means of known elements such as screws, glue, magnets. The support (or the suspension) of the device on the frame is thus implemented in a direction Ya-Ya′ at right angles to the axis of the winding tube X-X′.

In the example represented in FIG. 3, the second support element takes the form of a pin extending along an axis Z-Z′ parallel to the axis of the first support. A number of pins can form the support element. The torque recovery bar is thus held between the second support element of the motor end-plate and the second end-plate.

The torque neutralizing element can have a hollow end whose internal diameter corresponds to that of the pin to be plugged therein and mechanically held.

In place of the torque recovery element, a connection element (not represented) can be mounted on the second support element in the form of a pin. This connection element makes it possible to mount the device on a wall or a ceiling, while using an identical or almost identical end-plate for the two embodiments. The connection element is, for example, a bent element.

Each lateral element 7, 7′ produced in end-plate form also comprises the support elements mentioned, and elements 14 for masking and protecting the lateral parts of the winding, and possibly for guiding the latter in the case where an obstacle comes to modify the correct operation of the winding.

The motor end-plate also comprises, in the bore emerging on its outer face, a first guiding path 77 to store therein, for example, an antenna wire. This first guiding path can take the form of pins arranged facing one another and between which a part of the antenna cable can be wedged.

The inner face of the motor end-plate is hollowed and comprises, in addition to the reinforcing walls 78, also a second guiding path 79 between the first support element and the second support element. The inner face and the outer face are connected to one another, through a through hole 80 emerging from the inner face in the bore of the inner face. The through hole emerges outside the diameter of the housing of the actuator. This second guiding path makes it possible to accommodate a power supply wire (not represented), for example arriving along the torque recovery bar from the power supply device arranged at the other end of the winding tube, to the actuator, or arriving from a suspended ceiling along the second support. The power supply wire is then inserted through the through hole to the bore of the motor end-plate and can be connected to the electronic card or to the actuator through the bore of the support shaft.

The inner face of the end-plate also comprises an annular surface 81, on which, during mounting, the collar of the crown ring used as bearing bears on the winding tube. The surface condition and/or the small dimensions of this annular surface make it possible to minimize friction during operation.

One variant of the embodiments of the end-plate 7c is represented in FIGS. 6 to 10. This variant of the end-plate 7c may be carried out in the first and second embodiments of the invention. This end-plate 7c corresponds preferably to the head of the actuator, closing the hollow tubular housing 41 of the actuator. The actuator head is intended to be mounted on a supporting surface, as shown in the embodiments of FIGS. 1 and 2 or eventually on vertical surface such as a window or door posts, so as to support a motorized maneuvering device 1 for maneuvering a moving element.

This end-plate 7c is made of a circular plate which comprises an outer face 90 and an inner face 90a surrounded by a peripheral wall 96. The support 11 extends from the inner face 90a of the end-plate 7c. The support 11 is globally tubular and able to cooperate in form with the extremity of the hollow tubular housing of the actuator. It can be seen on FIG. 9 that the support 11 of the end-plate 7c extends substantially at right angle to the end-plate 7c from the inner face 90a. When the actuator head is mounted on the hollow tubular housing 41, the support 11 is inserted at least partially within the hollow tubular housing 41.

This end-plate 7c comprises on its outer face 90 at least one guiding path 100a, 100b, 100c formed by a groove and/or a hole in which a radio antenna 95 can be arranged. By “hole” is meant a cavity dug in the outer face 90 in order to receive or wedge a part of the antenna 95.

More specifically, the end-plate 7c includes two or three guiding paths: a first, a second and eventually a third guiding path 100a, 100b, 100c.

The first, second and third guiding paths 100a, 100b, 100c each comprise first and second ends 103, 104a, 104b, 104c. The first end 103 is common for these first, second and third guiding path 100a, 100b, 100c. In other words, the first, second and third guiding paths 100a, 100b, 100c have the same first end 103 which is situated near an antenna bore through which the antenna will pass from the electronic board inside the actuator hollow housing 41 to the outside. The second end 104a of the first guiding path 100a is situated in the outer face 90 of that end-plate 7c. Concerning the second and third guiding paths 100b, 100c, their second end 104b, 104c opens at an outer periphery or edge 97 of the end-plate 7c. More accurately, the second and third guiding paths 100b, 100c extend in the outer face 90 from their first end 103 to the outer periphery 97 of the outer face 90.

The first guiding path 100a extends along the outer face 90 from the first end 103 to the second end 104a and is divided into three parts 101a, 101b, 101c. The first part 101a comprises the first end 103 of the first guiding path 100a.

The second guiding path 100b extends in the outer face 90 from the first end 103 to its second end 104b and comprises two parts 102a, 102b. The first part 102a can be common with the first guiding path 100a, more precisely common to a constituting part of the first guiding path 100a. This first part 102a of the second guiding path is thus shared with the first guiding path 100a.

The third guiding path 100c of this end-plate 7c extends from the first end 103 to its second end 104c. This third guiding path 100c can be a groove preferably a rectilinear groove formed in the outer face 90. As already discussed, this third guiding path 100c may have portions common to the first and/or second guiding paths 100a, 100b.

The third guiding path preferably joins the outer periphery 97 of the outer face 90 in a direction orthogonal to the second guiding path 100b.

The guiding paths 100a, 100b, 100c can be rectilinear or curved grooves or grooves formed from portion at angles with each other, in the outer face 90. The grooves can be at least partly opened or covered. The guiding paths 100a, 100b, 100c can alternatively take the form of pins arranged facing one another as shown on FIG. 5.

It is well understood that in other alternatives, the first, second and third guiding paths 100a, 100b, 100c may be formed by a combination of linear or curved, covered and opened grooves and/or pins.

In the end-plate 7c, the inner and outer faces 90a, 90 communicate through a through-hole emerging in the first, second and third guiding paths 100a, 100b, 100c, more precisely in the first end 103 of these guiding paths 100a, 100b, 100c.

As we previously said, the actuator 4 can comprise an antenna 95 which can be for example an antenna wire or cable 95. This antenna 95 has two ends, one connected to an electronic card situated for example in the tube or at least partly in the support shaft 11, and the other one which is a free end. The free end of the antenna 95 is adapted for passing through the through-hole such that the antenna 95 is mainly located outside the hollow tubular housing 41 of the actuator 4.

The free end of the antenna 95 can be arranged and/or wedged in the end-plate 7c in different configurations:
a first configuration wherein the antenna 95 is placed in the first guiding path 100a, with preferably its free end arranged in the hole and a part of this antenna 95 wedged in the holder component 98;
a second configuration wherein the antenna 95 can be arranged in the second guiding path 100b, with preferably the free end of this antenna 95 which juts out of the peripheral wall 96 going through the hole formed by the second end 104b;
a third configuration wherein the antenna 95 can be arranged in the third guiding path 100c, with preferably the free end of this antenna 95 which juts out of the peripheral wall 96 going through the hole formed by the second end 104c.
eventually a fourth configuration where the antenna extends freely from the outer face 90.

The arrangement of the antenna 95 in the end-plate 7c in one of the different configurations is chosen at wish, according to the context in which the motorized maneuvering device 1 including this variant embodiment of the end-plate 7c is used. For example it may be chosen according to the installation of the motorized maneuvering device 1 in a home automation system or motorized screen system.

Thus, the invention also relates to a method of configuring the motorized maneuvering device 1, the method comprising the following steps:
Providing the motorized maneuvering device 1 comprising the end-plate 7a as previously disclosed and the radio antenna 95;
Shaping and setting the radio antenna 95 in the first guiding path 100a or shaping and setting the radio antenna 95 in the second guiding path 100b, or eventually shaping and setting the radio antenna 95 in the third guiding path 100c;
Eventually, the antenna can be shaped independently of any guiding path 100a, 100b, 100c and set freely in a first direction perpendicular to the end-plate outer plane.

Thus, the method of configuring the motorized maneuvering device 1 comprises the following steps:
Providing the motorized maneuvering device 1;
Removing the radio antenna 95 from the first guiding path 100a and shaping and setting the radio antenna 95 in a different configuration.

The last step of removing the radio antenna may also be implemented as follows:
Removing the radio antenna 95 from the first guiding path 100a and shaping and setting the radio antenna 95 in the second guiding path 100b or in the third guiding path 100c.

When placed in the second path 100b, the antenna 95 extends in a second radial direction out of the end-plate 7a. When placed in the third path 7c, the antenna 95 extends in a third radial direction out of the end-plate 7a. The second radial direction and the third radial direction as represented are orthogonal but any other configuration may be possible.

In all these configurations, the fact that the antenna 95 extends outside the actuator 4 improves the radio communication range of the actuator 4, especially in the case where the hollow tubular housing is metallic. In these two configurations, the fact that the antenna 95 extends partly freely out of the actuator 4 has a negative aesthetic impact but the operating range of the radio communication means is improved compared to when the antenna 95 is inside the hollow housing or shaped along the first guiding path 100a.

When placed in the first path 100a, the antenna 95 is completely integrated in the actuator 4. This is very interesting as there is no fragile part that hangs out of the actuator 4. The antenna 95 is thus safely stored especially during manufacture and transport. Depending on the configuration of the installation of the actuator 4 on site, the antenna 95 might remain in the first guide path 100a and still allow sufficient radio communication range. If the operating range of the radio communication means is considered to be too weak for the installation, the antenna 95 can easily be deployed in the second guide path 100b or eventually in the third guide path 100c or freely deployed, so as to extend outside any closed metallic environment (roller tube, shutter box) which impairs the radio communication means.

With an end-plate 7a according to the invention, the user can give priority to a protection criterion (where the antenna is safely stored within the actuator end plate) or to an operational range criterion (where the antenna 95 is deployed to increase the radio communication range), and configure the antenna 95 of the actuator 4 accordingly.

The invention also applies in the context of a moving element that cannot be wound on the tube, for example a blind of inverted type, of folded or ruffled type, the beads of which are wound on a shaft driven by the actuator, for example on a tube containing the power supply device. It also applies in the context of a screen of hinged type (shutter or gate), the power supply device of which would be housed in an actuation tube, for example a tube positioned at the level of the hinge pins.

1. An end-plate for a radio controlled motorized maneuvering device, the end-plate comprising:
a first guiding path formed by a groove in the end-plate,
the first guiding path being shaped for receiving and holding a radio antenna.

2. The end-plate according to claim 1, wherein the end-plate comprises a second guiding path formed by a groove in the end-plate, the second guiding paths being shaped for receiving and holding part of a radio antenna.

3. The end-plate according to claim 2, wherein the first and second guiding paths have a first common end and second ends.

4. The end plate according to claim 1, wherein the first guiding path comprises a part which extends in whole or in part along a perimeter of the outer face.

5. Motorized maneuvering device for maneuvering a moving element, the motorized maneuvering device comprising an end-plate according to claim 1 and a radio antenna.

6. Method of configuring a motorized maneuvering device, the method comprising:
providing a motorized maneuvering device for maneuvering a moving element, the motorized maneuvering device comprising an end-plate according to claim 1 and a radio antenna;
removing the radio antenna from the first guiding path and shaping and setting the radio antenna in a different configuration.

7. Method of configuring a motorized maneuvering device, the method comprising:
providing a motorized maneuvering device for maneuvering a moving element, the motorized maneuvering device comprising an end-plate according to claim 2 and a radio antenna;
removing the radio antenna from the first guiding path and shaping and setting the radio antenna-in the second guiding path.

8. Motorized maneuvering device for maneuvering a moving windable fabric screen, the motorized maneuvering device comprising:
an actuator, comprising a hollow housing-containing a motor and a gear,
a mounting end-plate, the end-plate-comprises a first support extending from the inner lateral face of the end-plate along a first longitudinal axis, the hollow housing of the actuator being closed by the first end-plate support,
wherein the end-plate comprises a first guiding path for an electrical wire in a bore on an outer lateral face of the end-plate.

9. Motorized device according to claim 8, wherein the first support comprises at least one first rotation stopping element and the housing comprises at least one second rotation stopping element, the first and second rotation stopping elements cooperating to link in rotation, the first support and the housing.

10. Motorized device according to claim 8, wherein the actuator comprises a radio receiver and the guiding path permits to store therein an antenna wire.

11. Motorized device according to claim 10, wherein the guiding path takes the form of pins arranged facing one another and between which a part of the antenna wire can be wedged.

12. Motorized device according to claim 8, wherein the end-plate comprises a cover intended to close the bore on the outer lateral face.

13. Motorized device according to claim 8, wherein the actuator comprises inside the hollow housing electromechanical components.

14. Motorized device according to claim 8, wherein the end-plate comprises a bore intended to receive a connection and/or electronic part of the actuator, said bore being produced inside the first support.

15. Motorized device according to claim 14, wherein the bore on the outer face of the end-plate and the bore produced inside the first support are connected to one another.

16. Motorized device according to claim 13, wherein the end-plate comprises a through hole between the bore produced inside the first support and an inner lateral face of the end-plate for the entry of a cable.

17. Motorized device according to claim 8, which comprises an annular surface on the inner lateral face of the end-plate against which a bearing ring mounted free to rotate about the housing of the actuator can bear.

18. Motorized device according to claim 8, wherein the first support cooperates with the housing of the actuator and the motorized device comprises a second support extending from the end-plate along a second axis distinct from the first axis.

19. A motorized home automation system comprising a motorized device according to claim 8, a bearing ring rotating freely on the housing of the actuator, a winding tube, mounted to slide on the bearing ring, the bearing ring bearing on the inner face of the end-plate and a second end-plate-comprising a winding tube support element; the system comprising a radio-receiver and a power supply device of the actuator comprising an electrical energy storage element.

20. The motorized home automation system according to claim 19, wherein the maneuvering actuator is inserted into the winding tube, at one end thereof, whereas the power supply device is inserted into the winding tube, at another end thereof.

21. The motorized home automation system according to claim 19, wherein the end-plate is fixed onto an accessory, wherein the accessory is added onto a frame or on a side of a casing.
